(19) United States
(12) Patent Application Publication
(10) Pub. No.: US 2026/0322311 A1
(43) Pub. Date: Oct. 15, 2026

(54) Supporting Solar Panels Above Bodies of Water

(71) Applicant: RCAM Technologies, Inc., Boulder, CO (US)

(72) Inventors: Jason Rust Cotrell, Boulder, CO (US); Eduardo Rangel, Boulder, CO (US)

(73) Assignee: RCAM Technologies, Inc., Boulder, CO (US)

(21) Appl. No.: 19/557,764

(22) Filed: Mar. 5, 2026

Related U.S. Application Data
(63) Continuation of application No. PCT/US2024/045785, filed on Sep. 9, 2024.
(60) Provisional application No. 63/581,198, filed on Sep. 7, 2023.
(60) Provisional application No. 63/585,287, filed on Sep. 26, 2023.

(51) Int. Cl. H02S 20/10; E02B 17/00; E02B 17/02

(52) U.S. Cl. CPC H02S 20/10; E02B 17/02; E02B 2017/0039; E02B 2017/0056

(57) ABSTRACT

In a general aspect, support structures are described for supporting solar panels over a body of water. In some implementations, the support structures include legs formed of cementitious material. Each leg has a length that is configured to position an upper end of the leg above a surface of the body of water when a lower end of the leg contacts a floor of the body of water. The support structures also include a platform formed of cementitious material and having beams and leg interfaces. Locking mechanisms may be used to selectively secure and unsecure the leg interfaces to the legs. The support structures additionally include a deck that is configured to couple to an upper surface of the platform and secure one or more solar panels to the support structure.

### CROSS-REFERENCE TO RELATED APPLICATIONS

This application claims priority to U.S. Prov. Pat. App. No. 63/581,198, which was filed on Sep. 7, 2023 and entitled, “Supporting Solar Panels Above Bodies of Water.” This application also claims priority to U.S. Prov. Pat. App. No. 63/585,287, which was filed on Sep. 26, 2023 and entitled, “Supporting Solar Panels Above Bodies of Water.” The disclosures of both priority applications are hereby incorporated herein by reference in their entirety.

### BACKGROUND

The following description relates to supporting solar panels above bodies of water.

Solar panels may be deployed on land and water to harvest light for generating electricity. The solar panels are typically mounted to a structure that secures the solar panels at a target location.

### DESCRIPTION OF DRAWINGS

FIG. 1A is a schematic diagram, in perspective view, of an example support structure for supporting solar panels over a body of water;

FIG. 1B is a schematic diagram, in front view, of the example support structure of FIG. 1A, but in which the example support structure includes multiple locking mechanisms;

FIG. 1C is a schematic diagram, in perspective view, the example support structure of FIG. 1A, but configured with pontoons as buoyant bodies;

FIG. 1D is a schematic diagram, in perspective view, of an example deployment method that includes floating the example support structure of FIG. 1C to a target location on a body of water;

FIG. 1E is a schematic diagram, in front view, of the example support structure of FIG. 1C, but in which the example support structure is secured to a floor of the body of water;

FIG. 2A is a schematic diagram, in perspective view, of an example support structure that includes a base configured to contact a floor of a body of water;

FIG. 2B is a schematic diagram, in perspective view, of the example support structure of FIG. 2A, but configured with pontoons as external buoyant bodies;

FIG. 2C is a schematic diagram, in perspective view, of the example support structure of FIG. 2A being lowered to an underwater target location using cables that are coupled to pontoons;

FIG. 2D is a schematic diagram, in perspective view, of the example support structure of FIG. 2A deployed at a target underwater location with marine life growing on and around its base;

FIG. 3A is a schematic diagram, in perspective view, of an example round 3D-printed floating solar support structure being manufactured at shore and pushed out to sea on a submersible barge for installation;

FIG. 3B is a schematic diagram, in perspective view, of an example 3D-printed floating solar support structure being manufactured on a dock;

FIG. 4A is a schematic diagram is presented, in perspective view of an example support structure for supporting solar panels over a canal;

FIG. 4B is a schematic diagram, in elevation view, of the example support structure of FIG. 4A;

FIG. 5A is a schematic diagram, in perspective view, of an example floating support structure moored to a floor of a body of water; and FIG. 5B is a schematic diagram, in elevation view, of the example floating support structure of FIG. 5A.

### DETAILED DESCRIPTION

In a general aspect, support structures are described for supporting solar panels over a body of water (e.g., a lake, a river, a sea, a canal, an ocean, etc.). The support structures may be configured to provide robust, low-cost free-standing support structures for supporting solar panels and electrical equipment above the body of water. In some implementations, the support structures include surfaces and geometries to promote the growth of marine life.

For example, a support structure may include a platform and legs formed of cementitious material. The platform couples to one or more solar panels, such as via a deck. In this way, the platform allows the support structure to support the one or more solar panels above the body of water. In certain cases, the platform may be movably coupled to the legs. For instance, the legs may be parallel to each other, and the platform may include sleeves that each slide along the length of a respective leg. The support structures may then include a means to selectively secure and unsecure the platform to the legs at a desired position along their length (e.g., adjacent the ends of the legs). In some variations, the support structures may utilize a mortar or grout to secure the platform to the legs (e.g., via a permanent joint). In some variations, the support structures may include a locking mechanism to selectively secure and unsecure the platform to the legs. In some variations, the legs may be formed as one monolithic structure. In some variations, the legs, the platform, and the deck may be formed as one monolithic structure.

As another example, a support structure may include legs having lower and upper ends. and connecting members between the legs at their lower ends. Each leg may have a length that extends between upper and lower ends of the leg, and the length is configured to position the upper end of the leg above a surface of the body of water when a base of the support structure contacts a floor of the body of water. The support structure may also include a base that is formed of cementitious material and configured to contact the floor of the body of water. The base includes a portion of each leg proximate its lower end as well as connecting members that connect respective pairs of the legs to each other proximate their lower ends. The base may, in certain cases, be analogous to a fixed-bottom platform of the support structure. The support structure additionally includes a deck that couples to the upper ends of the legs and secures one or more solar panels to the support structure.

Ground-mounted photovoltaics on farmland, fields, and deserts can provide the lowest cost photovoltaic (PV) installation but are facing increasing public resistance due to land-use conflicts and aesthetic concerns. Residential and commercial rooftop PV installations have substantial resource potential but can be more expensive. However, deploying PV panels on or above bodies of water can create opportunities for solar energy generation where ground-mount or rooftop systems are limited or infeasible. New dual-use PV technologies, such as canal solar, hydropower solar, aquaculture solar, and offshore solar perform one or more additional functions in addition to generating electricity, are in development that allow solar panels to be installed on or above bodies of water to mitigate land-use conflicts. These PV technologies can also provide benefits such as reduced water evaporation by increased shading, increased marine life growth by providing additional habitat or shade, or providing structure below the water surface for enclosing fish farms.

Offshore solar (OFS) applications may have the greatest gross potential resource of any offshore renewable technology. For example, the U.S. west, east, and southern coastlines and Great Lakes have a combined shoreline length of about 10,000 miles (excluding Alaska) and more than 1 million square miles of water surface area in the U.S. exclusive economic zone, which is about a third of the land area of the contiguous U.S. This vast area is estimated to have a gross resource potential of 326,000 GW, which is about 300 times the electrical generating capacity of the U.S. electrical system, and 30 times more than the U.S. offshore wind resource potential. The Gulf of Mexico alone may have 86,000 GW of gross resource potential, 46 times that of offshore wind in the Gulf. In addition, 40% of U.S. residents live in U.S. coastal counties which account for less than 10% of U.S. land area, creating more land conflicts. Hydropower solar, or the installation of solar on or above hydropower reservoirs, also has substantial potential at about 7,600 GW in the U.S. Moreover, canal solar, or solar panels built over water canals, also has significant U.S. resource potential of about 25 GW.

OFS applications have the potential to be less than half the present cost of offshore wind making it one of the lowest-cost clean energy options for over 142 million Americans in coastal regions. When combined with offshore wind or marine energy storage systems, OFS systems can also reduce the variability of renewable electricity generation and improve grid reliability. However, robust, low-cost OFS support structures are needed for U.S. oceans and Great Lakes. OFS support structures must withstand extreme offshore winds, waves, and currents from storms and hurricanes. Additionally, they may be exposed to ice flows in some climates and water bodies.

The predominate technology for OFS, is based on a floating solar construction. This construction mounts solar panels on a structure that floats on a body of water and is moored to the seafloor or reservoir bottom. Nearly all water-based PV systems in relatively deep water (e.g., deeper than approximately 2 m) are supported by the water surface (e.g., floated). The industry term for this PV application is “floating solar” systems or floating photovoltaics (FPV). The most common type of FPV affixes PV panels to floating plastic pontoons kept in place by mooring lines connected to anchors. Other solutions include floating membranes made from polymers and floating steel or aluminum platforms supported by buoyant columns or components in a semi-submersible arrangement. However, most floating solar systems are not capable of withstanding the extreme loads or water level variations needed for OFS deployment, or for regions with strong water currents (e.g. water canals or tidal regions). The few floating systems designed to withstand harsh offshore conditions are fabricated from expensive steel or aluminum components, making them cost prohibitive. In contrast, the support structures described herein can provide a robust, low-cost free-standing support structure that supports solar panels and electrical equipment above bodies of water.

In some implementations, the support structures do not float after installation. However, the support structures may float during transport to and from a target location (e.g., during the float-out and retrieval stages). In these implementations, the support structures may be supported by a rigid connection to an underwater floor (e.g., via an anchor) or a surrounding bank of a water canal. This configuration may be referred to as a “fixed bottom” solar installation.

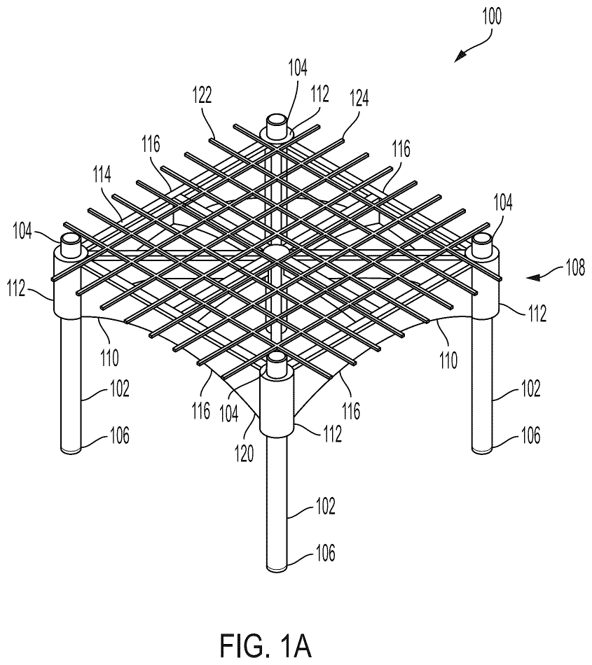

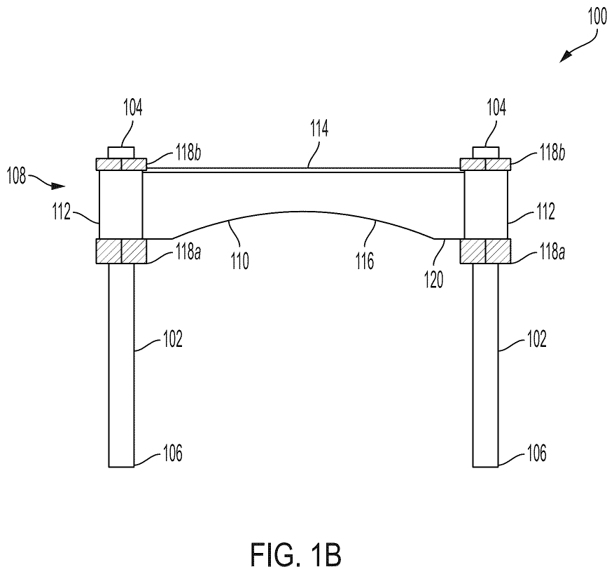

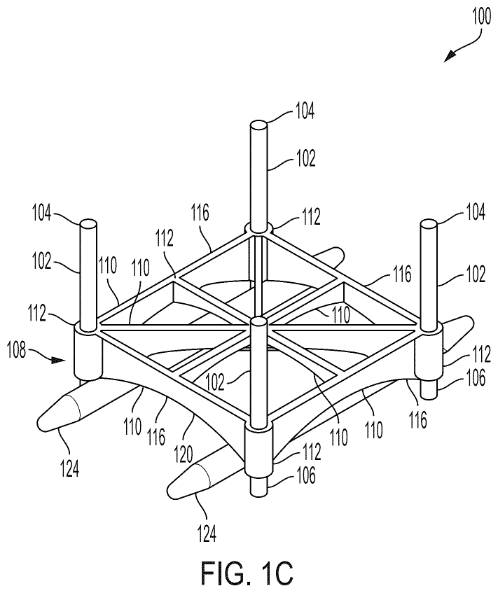

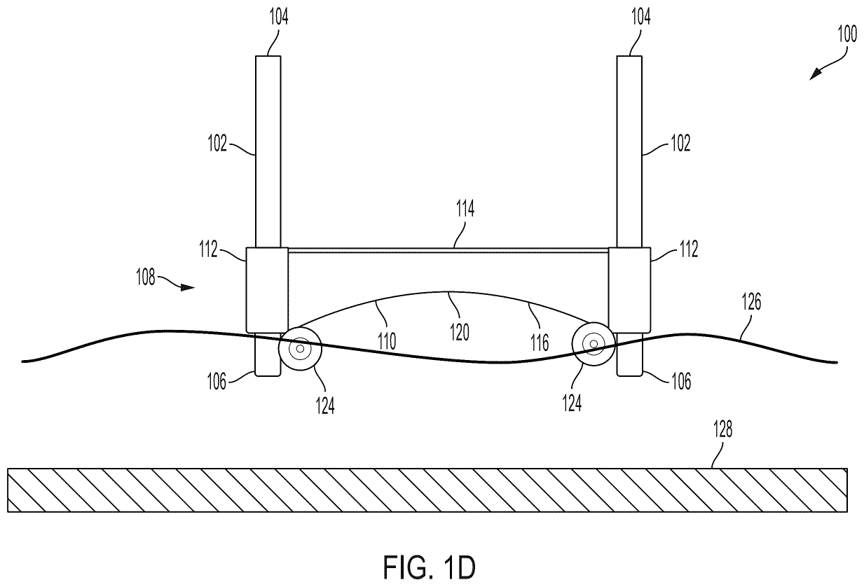

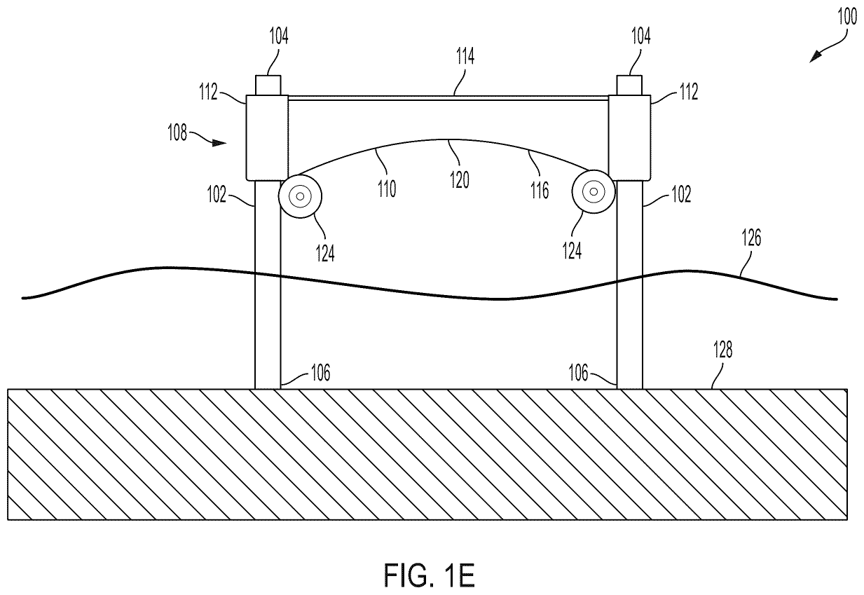

FIG. 1A presents a schematic diagram, in perspective view, of an example support structure 100 for supporting solar panels over a body of water. The example support structure 100 includes a solar platform and legs. The solar platform is raised to the top of the legs, and a solar panel deck is installed on the solar platform to support a bank of solar panels. The solar platform may be secured to the legs at a desired position along their lengths using mortar or grout. However, in some variations, the solar platform may be secured to the legs via a locking mechanism.

In some implementations, the example support structure 100 includes legs 102 formed of cementitious material. Each leg 102 has a length that is configured to position an upper end 104 of the leg 102 above a surface of the body of water when a lower end 106 of the leg 102 contacts a floor of the body of water. In some variations, the legs 102 are aligned parallel to each other. In some variations, the legs 102 have the same length. The example support structure 100 also includes a platform 108 formed of cementitious material that includes beams 110 and leg interfaces 112. The beams 110 define an upper surface 114 of the platform 108 and comprise one or more perimeter beams 116 that define a perimeter of the platform 108. Moreover, the leg interfaces 112 are each configured to couple to one of the legs 102. In some instances, one or both of the legs 102 and the platform 108 include layers of cementitious material that are successively deposited over one another by an additive manufacturing process (e.g., by 3D printing, by spray, etc.).

In some implementations, such as shown in FIG. 1A, the leg interfaces 112 are perimeter leg interfaces that disposed on the perimeter of the platform 108. However, in certain cases, the leg interfaces 112 may also include an interior leg interface that is disposed in an interior of the platform 108 (e.g., a portion of the platform 108 that is contained within the perimeter). In some implementations, the perimeter of the platform 108 includes one or more corners of the platform. In these implementations, the perimeter leg interfaces 112 include a corner leg interface that is disposed at the corner of the platform. FIG. 1A depicts the leg interfaces 112 as being all corner leg interfaces. However, the leg interfaces 112 may include other types of leg interfaces.

The example support structure 100 additionally includes locking mechanisms 118 that are each configured to selectively secure and unsecure one of the leg interfaces 112 to one of the legs 102. The locking mechanisms 118 also each allow the one leg interface, when unsecured, to move along at least a portion of the length of the one leg. FIG. 1B presents a schematic diagram, in front view, of the example support structure 100 of FIG. 1A, but in which the example support structure 100 includes multiple locking mechanisms 118. The locking mechanisms 118 may each include a lower clamp 118a on each leg 102, against which, a lower surface 120 of the platform 108 rests. In some instances, the locking mechanisms 118 may each also include an upper clamp 118b on each leg 102. The upper clamps 118b may be positioned relative to the lower clamps 118a on each leg 102 to sandwich the platform 108 in between. This configuration may prevent motion of the platform 108 along the lengths of the legs 102. Other configurations are possible for the locking mechanisms 118 (e.g., pins through holes in sleeve structures in the platform 108 and matching holes in the legs 102).

Now returning to FIG. 1A, the example support structure 100 may include a deck 122 that is configured to couple to the upper surface 114 of the platform 108 and secure one or more solar panels to the example support structure 100. For example, the deck 122 may include a scaffolding 124 that is configured to couple to the one or more solar panels. However, the deck 122 may include other components (e.g., beams, planks, etc.) in lieu of or in addition to the scaffolding. During manufacture of the example support structure 100, the leg interfaces 112 may be secured to one of the legs 102 by one of the locking mechanisms 118, and the deck 122 may be coupled to the upper surface 114 of the platform 108. Moreover, the one or more solar panels may be coupled to the deck 122. The resulting configuration may allow the example support structure 100 to be ready for deployment to a target location on the body of water. However, to assist in this deployment, the example support structure 100 may include one or more buoyant bodies (e.g., pontoons, inflatable bags or balloons, etc.).

For example, the beams 110 may define the lower surface 120 of the platform 108, and the example support structure 100 may include a buoyant body 124 that is coupled to the lower surface 120 of the platform 108. FIG. 1C presents a schematic diagram, in perspective view, of the example support structure 100 but configured with pontoons as buoyant bodies 124. The pontoons may allow the example support structure 100 to float on a surface 126 of the body of water, as shown in FIG. 1D. To facilitate this floatation, the locking mechanisms 118 may secure that platform 108 at a location on the lengths of the legs 102 proximate their lower ends 106. When the example support structure 100 reaches the target location on the body of water, the locking mechanisms 118 may unsecure the leg interfaces 112 from the legs 102 to allow the legs 102 to be lowered towards a floor 128 of the body of water. Once the lower ends 106 of the legs 102 are in contact with the floor 128, the locking mechanisms 118 may then re-secure the leg interfaces 112 to their respective legs 102.

In some implementations, the leg interfaces 112 include a sleeve structure that is configured to contain a portion of one of the legs 102 therein. This sleeve structure may facilitate the up and down movement of the legs 102 relative to the platform 108. In some implementations, the example support structure 100 may include “jack-up” legs. For example, the legs 102 may each comprise a linear gear along at least a portion of the length of the leg 102. In these cases, the leg interfaces 112 may each include a circular gear that is configured to engage one of the linear gears of the legs 102. In some implementations, the locking mechanisms 118 each include a motor that is configured to couple to one of the circular gears of the leg interfaces 112. During operation, the motors may rotate the circular gears, thereby moving the legs 102 up or down relative to their leg interfaces 112. The motors may also secure the leg interfaces 112 to the legs 102, such as by positioning (e.g., holding) the leg interfaces 112 at respective target locations along the lengths of the legs 102.

The example support structure 100 may include features that help anchor the legs 102 to the floor 128 of the body of water. For example, the legs 102 of the example support structure 100 may each have an outer diameter that increases in size proximate the lower end 106 of the leg 102. By providing an enlarged area to contact the floor 128 of the body of water, the one or more legs 102 may reduce the risk of the example support structure 100 sinking into the floor 128, especially if the floor 128 is made of softer soil. As another example, the lower end 106 of at least one of the legs 102 may include a suction chamber that is configured to embed the lower end 106 of the at least one leg 102 into the floor 128 of the body of water. The suction chamber may allow the example support structure 100 to resist lateral forces (e.g., due to wind, waves, and water currents, etc.) that might otherwise displace the example support structure 100 along the floor 128 of the body of water or possibly overturn the example support structure 100. In some implementations, the legs 102 may include a hollow leg that has an internal cavity extending along at least a portion of the length of the hollow leg. In certain cases, the internal cavity may define a channel for transporting water away from the lower end of the hollow leg, such as for operation of a suction chamber at the lower end. However, other configurations and purposes are possible for the internal cavity (e.g., weight reduction, conduits for electrical cables, etc.).

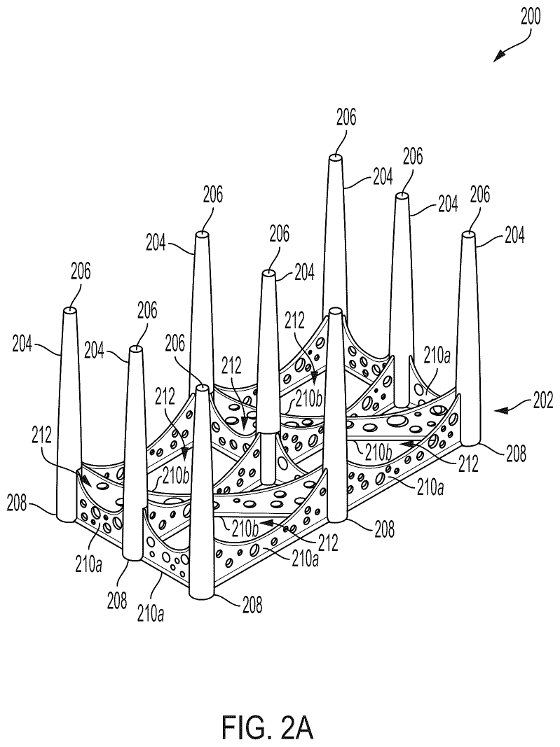

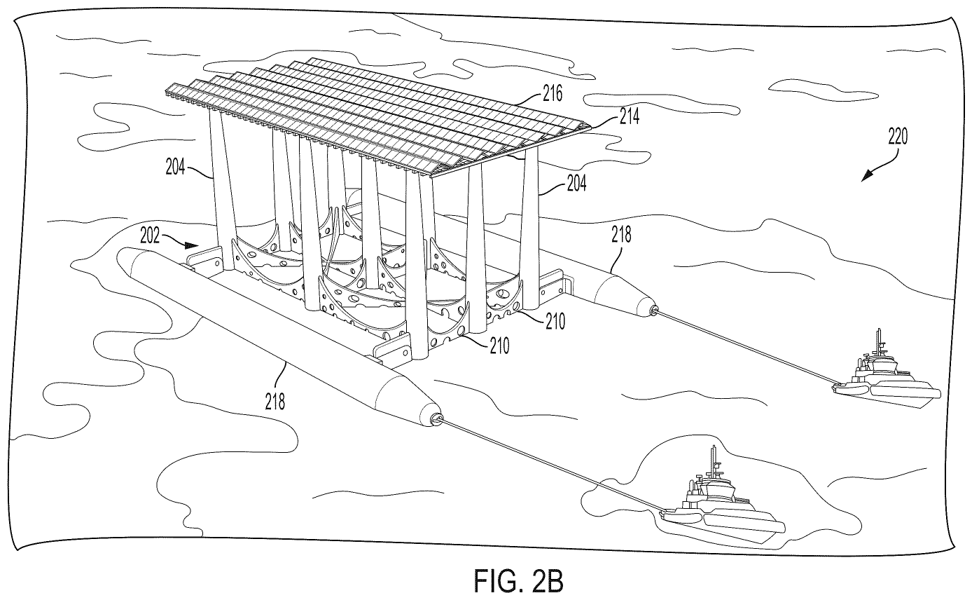

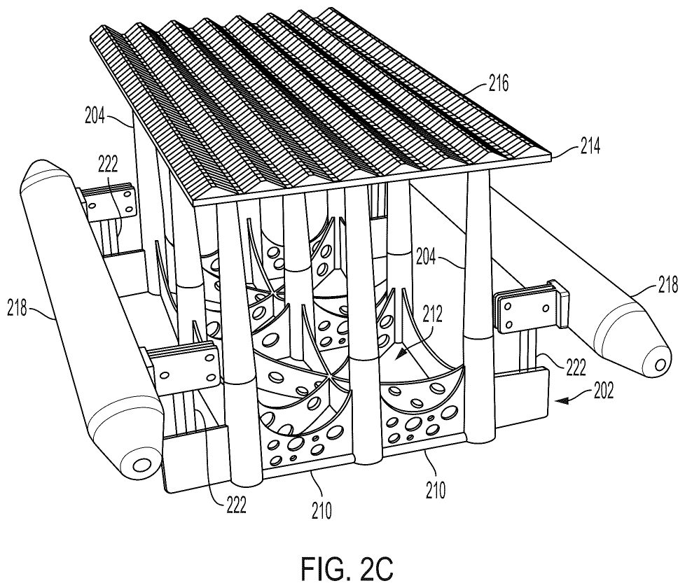

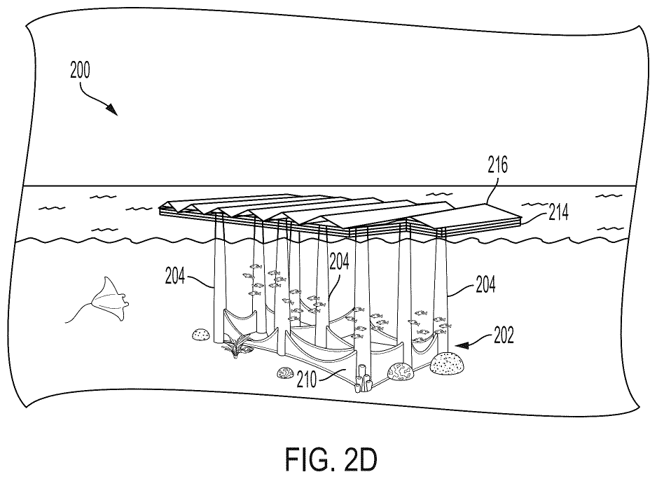

Now referring to FIG. 2A, a schematic diagram is presented, in perspective view, of an example support structure 200 that includes a base 202 configured to contact a floor of a body of water. In some instances, the base 202 may include structural features to promote the growth of marine life (e.g., holes, nooks, textured surfaces, simulated coral surfaces, etc.). In some instances, the base 202 may also be formed of a material whose chemistry promotes marine life growth and colonization on the structural features.

The example support structure 200 includes legs 204 formed of cementitious material. Each leg 204 has a length that extends between an upper end 206 and a lower end 208 of the leg 204. The length is configured to position the upper end 206 of the leg 204 above a surface of the body of water when the base 202 of the example support structure 200 contacts a floor of the body of water. The legs 204 may be aligned parallel to each other, and in certain cases, have the same length. In some implementations, the legs 204 include layers of cementitious material that are successively deposited over one another by an additive manufacturing process (e.g., by 3D printing, by spray, etc.). In some implementations, the legs 204 may include a hollow leg having an internal cavity that extends along at least a portion of the length of the hollow leg.

The base 202 is formed of cementitious material and includes a portion of each leg 204 proximate its lower end 208. The base 202 also includes connecting members 210 that connect respective pairs of the legs 204 to each other proximate their lower ends 208. The connecting member 210 may, in certain cases, include structural features to promote the growth of marine life (e.g., holes, nooks, textured surfaces, simulated coral surfaces, etc.). The base 202 additionally includes compartments 212 whose perimeters are defined by three or more of the connecting members 210. In some implementations, such as shown in FIG. 2A, the connecting members 210 include perimeter connecting members 210a that define, at least in part, a perimeter of the base 202. The connecting members 210 may also include intersecting connecting members 210b that intersect with at least one other intersecting connecting member 210b. In some implementations, the base 202 includes layers of cementitious material that are successively deposited over one another by an additive manufacturing process (e.g., by 3D printing, by spray, etc.).

The example support structure 200 also includes a deck 214 that is configured to couple to the upper ends 206 of the legs 202 and secure one or more solar panels 216 to the example support structure 200. The deck 214 may include a scaffolding that is configured to couple to the one or more solar panels 216. However, the deck 214 may include other components (e.g., beams, planks, etc.) in lieu of or in addition to the scaffolding. During manufacture of the example support structure 200, the deck 214 may be coupled to the upper ends 206 of the legs 204, and the one or more solar panels may be coupled to the deck 214. The resulting configuration may allow the example support structure 200 to be ready for deployment to a target location on the body of water. However, to assist in this deployment, the example support structure 200 may include one or more buoyant bodies (e.g., pontoons, inflatable bags or balloons, etc.).

For example, the connecting members 210 may include perimeter connecting members 210a that define, at least in part, the perimeter of the base 202. Moreover, the legs 204 may include perimeter legs disposed on the perimeter of the base 202. In these cases, the example support structure 200 may include an exterior buoyant body 218 that is coupled to at least one of the perimeter legs and resides exterior to the base 202. FIG. 2B presents a schematic diagram, in perspective view, of the example support structure 200 but configured with pontoons as external buoyant bodies 218. The pontoons may allow the example support structure 200 to float on a surface 220 of the body of water, such as to reach a target location on the body of water. As another example, the example support structure 200 may include an interior buoyant body that is coupled to at least one of the connecting members 210 and resides interior to one of the compartments 212 of the base 202. The interior buoyant body may be used together with or in lieu of the external buoyant bodies 218.

During deployment, the example support structure 200 may be floated, by operation of one or more buoyant bodies, from a first location on the body of water (e.g., a dock) to a second location on the body of water (e.g., an offshore location). The one or more buoyant bodies may be coupled to the base 202 of the example support structure 200. After reaching the second location, the example the support structure 200 may be lowered onto the floor of the body of water, such as to a target underwater location. The target underwater location may be below the second location on the body of water. FIG. 2C presents a schematic diagram, in perspective view, of the example support structure 200 being lowered to an underwater target location using cables 222 that are coupled to pontoons. The pontoons may be floating on the surface of the body of water. To facilitate lowering the example support structure 200, the one or more buoyant bodies may be decoupled from the base 202 of the example support structure 200. In certain cases, the one or more buoyant bodies may include an inflatable buoyant body. In these cases, lowering the example support structure 200 may include deflating, at least in part, the inflatable buoyant body.

Once the target underwater location has been reached, the base 202 of the example support structure 200 may contact the floor of the body of water. Such contact may, in certain cases, mark the end of the deployment of the example support structure 200. However, in some instances, the example support structure 200 may be secured against the floor of the body of water. For example, ballast (e.g., rocks, sand, concrete, etc.) may be disposed into one or more of the compartments 212 of the base 202 after the base 202 contacts the floor of the body of water. As another example, an anchor may be embedded in the floor of the body of water, and the example support structure 200 may be moored to the anchor after the base 202 contacts the floor of the body of water. FIG. 2D presents a schematic diagram, in perspective view, of the example support structure 200 deployed at a target underwater location with marine life growing on and around the base 202.

In some implementations, the base 202 includes a base surface that contacts the floor of the body of water. In these implementations, at least one of the connecting members 210 may include a penetrating surface that is part of the base surface. As such, the at least one connecting member 210 may penetrate the floor of the body of water when the base 202 contacts the floor. The penetration surfaces may thus allow the example support structure 200 to resist lateral forces (e.g., due to wind, waves, and water currents, etc.) that might otherwise displace the example support structure 200 along the floor of the body of water or possibly overturn the example support structure 200.

In some implementations, the support structures include features that reduce cost and increase robustness. For example, the support structures may include a concrete platform that is supported by legs extending to the sea floor, such as shown in FIG. 1A. The support structures may also include a light weight, rib-stiffened arched or vaulted solar platform. In this configuration, the concrete platform may support the solar panels in a structurally efficient manner to reduce materials usage and cost. As another example, the support structures can include jack-up legs that are lowered to raise and support the platform when at the installation site. In some implementations, the beams, legs, or deck of the support structure may be formed as one monolithic structure to reduce interfaces and the number of parts. In some variations, the support structures are constructed using a method of automated fabrication. For example, the platform can be constructed using 3D printing with concrete on a simplified formwork.

The support structures can also be deployed to a target location on a body of water using flotation. For instance, the support structures can use a method of floating the platform-ideally, fully assembled with the solar panels-to the target location using integrated or removeable buoyant bodies, such as pontoons, inflatable bags or balloons, and so forth. The buoyant bodies can be removed after jacking-up the platform and transported back to shore for reuse, such as shown in FIGS. 1C-1E. FIG. 1C presents an example deployment method that uses pontoons for supporting the example support structure 100 during its transport to a target location on a body of water. FIG. 1D presents the example support structure 100, but in which the example support structure is floating via the pontoons on a body of water. In FIG. 1E, the example support structure 100 is secured to an underwater floor of the body of water and the platform 108 has been raised to a target position (e.g., a target height over the water surface). In FIG. 2B, the example support structure 200, which is supported by pontoons, is being pulled out to sea by a vessel. In FIG. 2C, the example support structure 200 is being lowered to the seafloor using cables supported by pontoons on the body of water. Other types of floatation bodies, such as a barge or inflatable bags, can also be used to provide temporary buoyancy for the platform to float the support structure to the installation site before jacking up the legs for installation or lowering the structure to the seafloor.

In some implementations, the support structures are configured for multi-use applications. The platform is versatile and can be used to support solar panels in dual-use applications. The examples of possible dual-use applications include canal solar (e.g. solar over water canals), hydropower solar (e.g. solar over water reservoirs), parking solar (e.g., solar over parking lots), and aquaculture solar (e.g. solar over ocean fish farms) to provide a secondary function beyond generating solar energy. For canal solar and hydropower solar applications, the support structures can be configured to span or rise above freshwater bodies to shade them, thereby reducing water evaporation and algae growth. For parking solar applications, the fixed bottom support structures can be installed over parking lots or over boats in marinas to provide solar energy for uses such as charging electric cars or boats. For aquaculture solar applications, the platform can be located near or above aquaculture pens for fish or other marine life, and the legs can be used as posts around which to enclose marine life with nets or screens. The support structures can also be used to hold energy storage systems and electrical equipment housed in containers holding batteries and power electronics needed to convert the DC solar electricity to AC. Moreover, systems incorporating the support structures and their solar panels can be combined with other types of marine energy, such as wind plants and wave energy plants as hybrid power plants.

In some implementations, the platform and leg assembly are configured to be hoisted into place at the installation site using a crane or other heavy-lift equipment instead of being floated to the site or instead of using jack-up legs. In some implementations, the platform and leg assemblies are configured to be fabricated in several different modular pieces that fasten together for use over larger installations. The modular pieces may also facilitate manufacturing and transport of large components which are manufactured away from the installation site such as at a factory. In some implementations, the platform and leg assembly are configured to be fabricated in one contiguous piece (including the legs or beams) to increase strength or reduce the number of parts. Such construction may reduce the number of components and field assembly operations. In some implementations, the platform is configured to be solid with a thin slab fabricated between the beams. This configuration may provide additional shear strength and stiffness. Moreover, a solid platform can, in certain cases, be used to form a water collection system that collects rainwater that can be used to clean the panels. The rainwater can optionally be stored in the legs of the support structure. In some implementations, the legs may be solid. In other implementations the legs may be hollow. In some implementations, the legs may include (e.g., contain) electrical cables that are used to transmit electricity to and from the electrical equipment on the platform. In certain cases, the electrical cables may also be used to transmit electricity to and from an underwear (e.g., subsea) electrical cable.

In some implementations, the space between the platform beams can be left open to reduce the platform mass or to allow sunlight to reflect off the water onto the back of the panels. Such reflection may create more energy, such as when using bifacial solar panels that absorb energy on both sides of the panel. In some implementations, the support structures are configured to allow the solar panels to be fastened directly to the cementitious material, or alternatively, a secondary frame (a deck) installed on top of the platform. The deck may increase the number of installation surfaces for solar panels, and in certain configurations, extend the edges of the solar installation beyond the footprint of the platform to increase the area of solar collection. In some implementations, beams connecting the legs are located at a lower location on the legs such as the midspan of the legs or near the seafloor to promote growth of marine life on the beams.

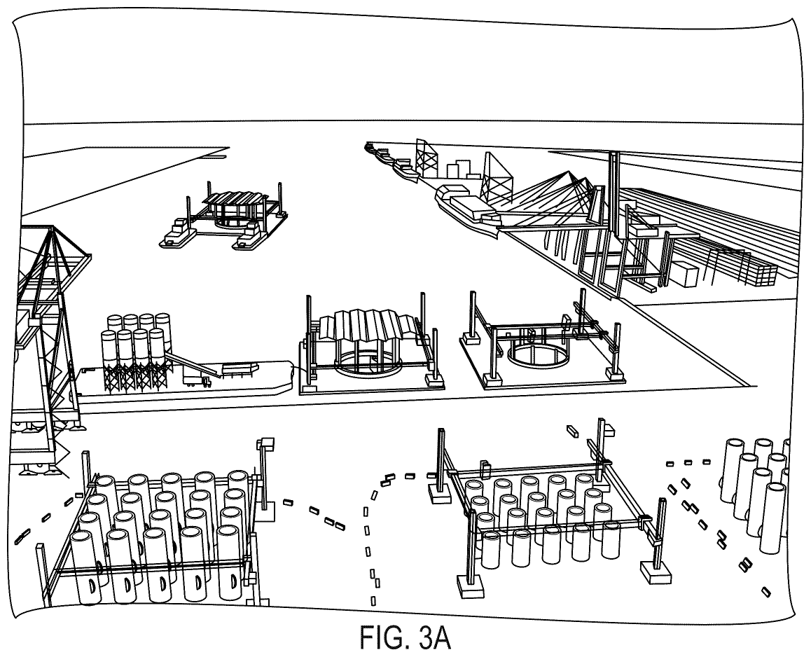

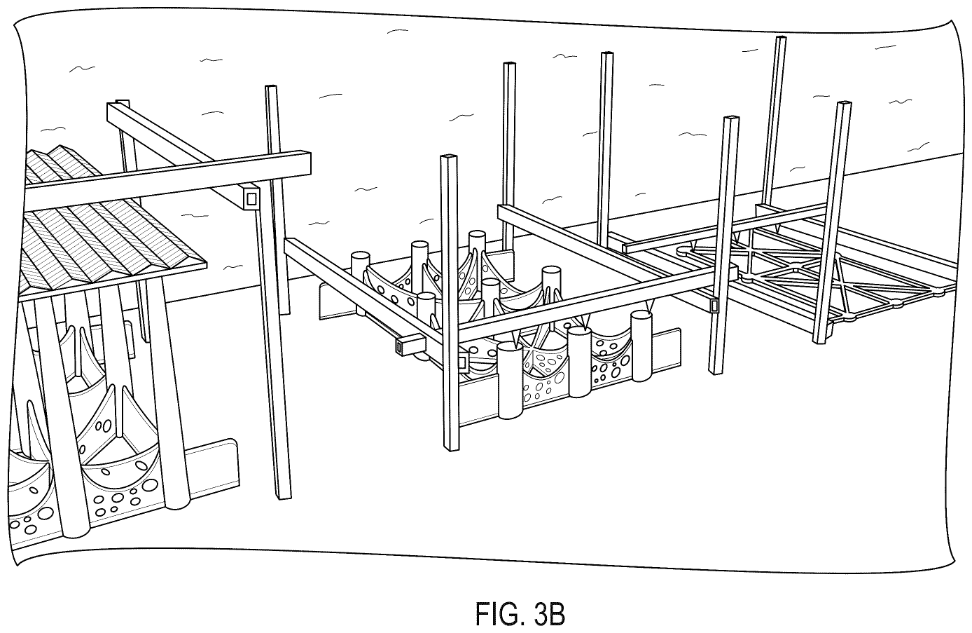

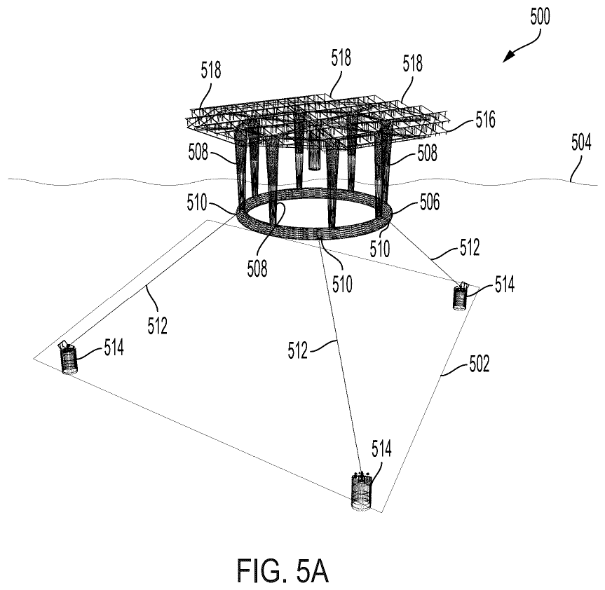

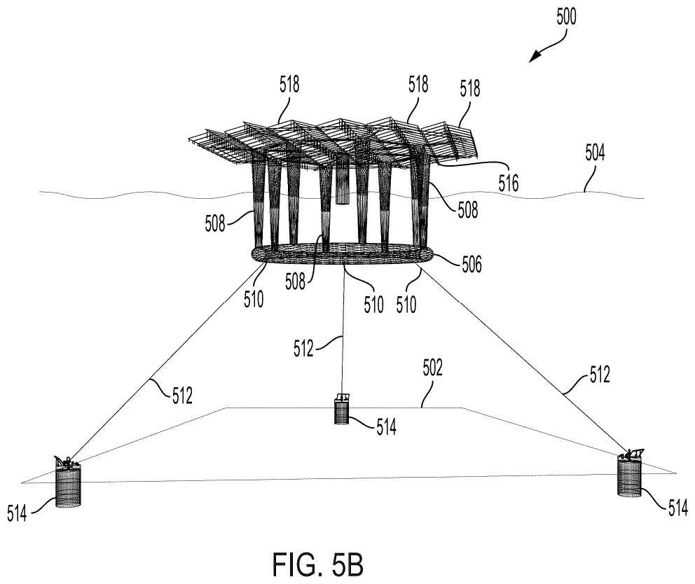

In some implementations, the platform is configured to be parallel to the water surface or inclined at an angle to increase solar radiation when installed at locations away from the equator. Moreover, the platform can take any necessary platform shape and be configured to use three or more legs. For example, the platform can be triangular with three legs, hexagonal, round, or rectangular with four, five, or six or more legs. Other configurations are possible. In some implementations, the lower ends of the legs are larger in diameter to distribute the weight of the structure over a larger surface (e.g., for soft underwater floors). In some implementations, the beams connecting the legs are located near the seafloor to provide additional bearing area to support the platform on the seafloor or form a skirt that embeds in the seafloor to reduce scour of the seabed from water currents. The beams and legs can also have features to increase the penetration depth such as tapered edges. Alternatively, the bottoms of the legs can include hollow chambers as well as ports or valves. The ports or valves can be open or closed to allow the legs to generate suction in the hollow chambers in response to leg displacements, thereby resisting overturning forces. In some implementations, the solar panels can be inclined on the deck at various angles or be flat on the deck. The solar panels can be spaced to reduce shading or connected to adjacent panels, such as shown in FIGS. 2B-2D and 3A. In some implementations, the platform is configured to float after installation (a floating platform) and be moored to the sea floor using mooring lines and anchors for deep water installation, such as shown in FIG. 5A.

In some implementations, the support structures are constructed using cementitious material. The cementitious material may include cement and aggregate (e.g., sand or gravel). In some instances, the cementitious material may also include reinforcing elements, such as fibers (e.g., steel fibers, polymer fibers, basalt fibers, glass fibers, etc.), rebar (e.g., steel rebar, basalt rebar, etc.), mesh (e.g., steel mesh, fiber mesh, etc.), cables, tendons, staples, and so forth. In some variations, the platform is formed at least in part of cementitious materials. In some variations, the legs are each formed at least in part of cementitious materials. In some variations, the platform is formed using steel materials (e.g. steel plates, tubes, etc.). In some variations, the legs are formed in least a part of steel materials (e.g. steel tubes).

In some implementations, the support structures can be fabricated using conventional concrete manufacturing methods such as casting in forms, pre-casting, advanced concrete manufacturing such as 3D concrete printing (3DCP) technologies, or combinations of such methods. 3DCP provides advantages because it eliminates the costly and labor-intensive formwork required by traditional casting methods. 3DCP also allows cost-effective, fast manufacturing throughput with a smaller footprint in space-constrained manufacturing sites or buildings. In addition, as illustrated in FIGS. 3A and 3B, 3DCP is well suited to fabricate very large structures and can be performed on the dock. 3DCP can also be performed on a floating dry dock, as illustrated in FIG. 3A, that can be towed out and submerged in deeper water to launch OFS systems of virtually any size and mass. 3DCP can encompass several technologies, including binder jetting, spray, and extrusion. A variety of 3DCP reinforcement strategies for both steel and non-metallic reinforcements can be used to quickly build large components, such as curved walls and beams needed for renewable energy applications. 3DCP printers are commercially available for objects up to 20-m in height and width. In some variations, the platform can be manufactured upside down, so that the arched beams, deck, or platform can be 3D printed without overhangs. In some variations, the platform can be printed right side up with temporary supports under the beams, deck, or platforms (such as formwork) on which to print the first layers of the arches.

In some implementations, the buoyant bodies (e.g., pontoons) can be manufactured from welded tubular metal (steel or aluminum), polymers, or cementitious material (e.g., concrete). As shown in FIGS. 1C-1E, pontoons can be attached to the platform beams and may, in certain cases, use steel plates or extensions that extend from the pontoons to the beams. As shown in FIGS. 2B-2C, pontoons can also be attached to the legs and may, in certain cases, use steel plates or extensions that extend from the pontoons to the beams. In some instances, the buoyant bodies can also be integrated into the support structures by using beams or legs that have a hollow internal cavity.

In some implementations, the support structures are configured to include one or more features. The features may include: (1) Supporting the support structures rigidly on the seafloor using a rigid platform made only from beams (not a solid platform) supported with precast concrete legs that can be used to support the platform during jacking and after installation; (2) A 3D printable frame or deck manufactured in one piece with arched members in a rectangle approximately 50-m wide by 100-m long using low-cost concrete materials and automated manufacturing; (3) Deck space that extends over the edges of the platform and contains space for supporting more solar panels, battery energy storage systems, and sacrificial landing zones for birds so they do not perch and soil the solar panel area; (4) Bifacial panels arranged in an east-west configuration (e.g., see FIG. 3A) high above the sea surface to maximize panel packing density and allow sun from the edges space to reflect and strike the back of the panels; (5) Removeable steel pontoons temporarily supported below by the beams that can be reused after installation at the deployment site; (6) A quick, low-risk support structure installation method that uses hoisting equipment such as gears and pinions, strand jacks, winches, and a power supply that all can be removed and reused for other installations; (7) A water collection system under the panels and water storage and filtering systems in the pontoon legs; and (8) An electrical cable that extends from the deck to the seafloor through a leg; (9) An underwater foundation connecting the legs and additional surfaces and geometries (i.e. holes, nooks, and simulated coral surfaces) that promote marine life growth and colonization. Other features are possible.

In some implementations, the platform is configured to be manufactured from low cost, durable cementitious material such as reinforced concrete instead of steel and aluminum support structures. For example, when formed of cementitious material, the platform can be configured to be more structurally efficient, reducing material usage, than with a conventional rectangular concrete slab. This configuration may include vaulting the bottom surface or beams along one or more edges. Thin ribs and/or a diaphragm can also be used to further stiffen the platform while minimizing mass, such as shown in FIG. 1A. In some variations, the cementitious components and reinforcement materials can be cast into a mold or 3D printed on top of a curved, removeable formwork. Alternatively, the structure can be printed upside down with the top of the fixed bottom platform on top of a flat surface.

In some implementations, the support structures are configured to float fully assembled or partially assembled solar platforms to the installation site, including, and if desired, the legs, jacks, electrical equipment such a inverters, transformers, or batteries for energy storage. This capability stands in contrast to other fixed bottom solar platforms that are designed for relatively shallow water and are assembled in-place. These other solar platforms are typically supported with a large number of pre-installed piles in an arrangement that is basically a land-based solar array.

In some implementations, the support structures are configured to use jack up legs to raise the platform. The jack up legs can have spread feet to distribute the weight of the platform on the seafloor. In some variations, the jack up legs can have built in suction chamber into the feet to provide overturning resistance. The jack up legs can also be hammered, vibrated, or screwed into the seafloor like piles.

In some implementations, the support structures include a buoyant body (e.g., a pontoon, an integral buoyancy chamber, an inflatable bag or balloon, etc.). Several types of removeable buoyant bodies can be temporarily or permanently incorporated into the platform to provide buoyancy during float out. The use of steel pontoons attached to the two longer sides of a rectangular platform is one example configuration (e.g., see FIGS. 1C-1E and 2B-2C). The buoyant bodies can provide a more stable (e.g., seaworthy) configuration and can reduce water drag on the platform during float out. The buoyant bodies may also reduce the number of floats. In some variations, the buoyant bodies can be hoisted up with the platform during installation to provide a smoother transition during the jack up process. The jack up process may, for example, occur between a buoyant state and a fixed bottom state (e.g., contact with an underwater floor). In some instances, the fixed bottom state may result in potential dynamic impacts between the buoyant bodies and the platform, such as from their independent motions caused by waves. In some variations, the buoyant bodies can be filled with ballast and submerged with the platform during installation. Alternative methods of providing buoyancy, such as float out of the solar platform on a barge, can risk impacts (e.g., slamming) between the platform and the barge when the platform is supported rigidly on an underwater floor and the barge is moved by the waves.

In some implementations, the legs of the jack up structure can be used to store clean water for panel cleaning. The clean water may be collected from the rain as part of a rainwater collection system or as part of a water desalination system. In some implementations, the legs and the platform are configured so that the top surface of the platform can be horizontal after installation or be inclined to increase solar irradiation. Alternatively, the platform or a secondary deck can be inclined, or individual panels can be inclined. The platform can also be elevated and configured to have an open framework of members to allow sunlight reflected off the ocean to pass through the platform. Such reflection may then strike the back of bifacial panels to generate additional solar electricity. In some implementations, the solar panels are installed on single-axis rotational tracking systems to adjust the position of a solar panel along an axis to follow the sun's changing position throughout the day.

In some implementations, the support structure is part of or defines an offshore solar (OFS) system. In these implementations, the support structure may provide features to the OFS system that result in advantages over other solar systems, such as floating OFS systems. For example, a fixed bottom support structure may be the most cost effective and robust solution for extreme winds and waves. Floating energy systems such as offshore wind are generally less robust and significantly more expensive than fixed-bottom systems. This additional cost may be due to the increased complexity, risk, and the cost of the mooring systems and dynamics of floating support structures.

When configured with a robust fixed bottom, the support structures can be simple and robust and may allow for another set of advantages stems. For example, certain OFS floating systems may use articulated joints or floating membranes that are designed for extreme waves up to 13.5 m and milder winds. However, the U.S. West Coast can experience 21-meter waves in some areas, and the Gulf of Mexico can experience Category 5 hurricanes. In some variations, the support structures lack joints between panels, mooring lines, or anchors and can be built upon legs that extend 20 m to 30 m above the water surface. This extension may be above extreme waves, thereby allowing the support structures to cost effectively handle U.S. offshore conditions. Furthermore, floats, mooring lines, or floating electrical cables for traditional systems can be damaged by ship anchors or the sea ice of ice flows. As such, the traditional systems could create giant floating hazards if they break free.

The support structures may offer several environmental advantages. The absence of mooring lines and anchors avoids environmental impacts such as biofouling, marine-life entanglements, mooring line scour, and anchor drag. In addition, traditional floating systems can use up to 30 anchors per MW of installed solar panel capacity. In contrast, the support structures may, in certain cases, use only 1 to 4 legs per-MW of solar capacity, reducing seafloor penetrations and seabed scour. The support structure can include underwater surfaces and geometries (e.g., holes, nooks, and simulated coral surfaces) that promote marine life growth and colonization. For fixed bottom systems that rest on the seafloor, unlike floating systems, the support structure can be designed to support the additional mass of marine life growth on the structure. The support structures may also reduce a carbon footprint approximately 50% compared to steel solutions by using low-carbon cementitious materials instead of aluminum or painted steel.

In some implementations, the support structures may be configured to offer advantages over floating solar installations. For example, in some variations, the support structures are configured to be robust. In these cases, the support structures may utilize a fixed bottom configuration that is less impacted by waves, currents, and biofouling than FPV systems. FPV systems have much more surface area at the water level and are thus more impacted by waves, currents, and biofouling. Floating systems also use mooring lines and floating electrical cables that can be damaged by the additional mass from biofouling. The fixed bottom configuration may also be more structurally resistant to hurricanes.

In some implementations, the support structures are based on a simple static configuration (e.g., a fixed bottom platform) that is lower risk than dynamic systems. The absence of mooring lines, anchors, and floating electrical cables greatly simplifies and improves the reliability of the fixed bottom configuration compared to traditional FPV systems. FPV systems can require up to 30 anchors per MW while the fixed bottom platform can have as few as 4 connection points (e.g., 4 legs) to the underwater floor per MW. The simpler configuration also reduces a variety of challenges that are commonly associated with mooring floating systems, including simpler installation in uneven ground, variations in water level, reduced inspections, and reduction of dynamic or snap loads in shallow water that are caused when mooring lines go slack and then quickly are pulled taut by wave motions.

In some implementations, the support structures have a lower capital expenditure cost. The support structures can be lower in cost than a traditional FPV system due to their less complex design, reduced installation cost, and the elimination of certain componentry such as mooring lines, floating electrical cables, and anchors. The use of low-cost cementitious materials and automated construction can reduce capital expenditures to be approximately 50% less than steel fixed bottom platforms. The cementitious materials can also be designed to be more durable than steel by using non-ferrous reinforcement materials such as basalt.

In some implementations, the support structures have reduced operation and maintenance costs. For example, floating systems and mooring lines are maintenance prone due to marine life growth and wear and tear. In addition, steel structures in the ocean require more frequent maintenance than concrete to mitigate corrosion. The number of mooring lines can also become entangled with free-floating items in the ocean like fish nets or be snagged by anchors. The support structures may also be configured to elevate solar panels off the surface of a body of water. This elevation can reduce the soiling of solar panels due to saltwater spray, thereby reducing the need for cleaning and reducing the risk of water contaminating the electrical equipment.

The support structures may also be more environmentally friendly. In some implementations, the support structures may have a “fixed bottom” configuration that brings several environmental advantages. For example, the elimination of mooring lines can reduce animal entanglement risk. The reduction in the number of seafloor connection points can also reduce the amount of geotechnical survey work and the risk of soil scour. Moreover, the legs or beams of the support structures can be configured to encourage sea life growth without affecting the buoyancy of a floating structure. The surfaces of the concrete structure underwater may also be manufactured with eco-friendly materials or surface geometries to encourage or discourage desired types of marine growth.

The support structures may also be safer and more secure. In case of structural failure, the support structures may fall benignly to the underwater floor, avoiding large floating and drifting hazards such as mooring lines, floats, or panels that could occur with floating systems. Furthermore, it can be safer to board and maintain a fixed structure than a moving floating structure. The elevated support structures may also be more visible from ships, thereby reducing the chance of collisions and allowing installation in areas with more ship activity.

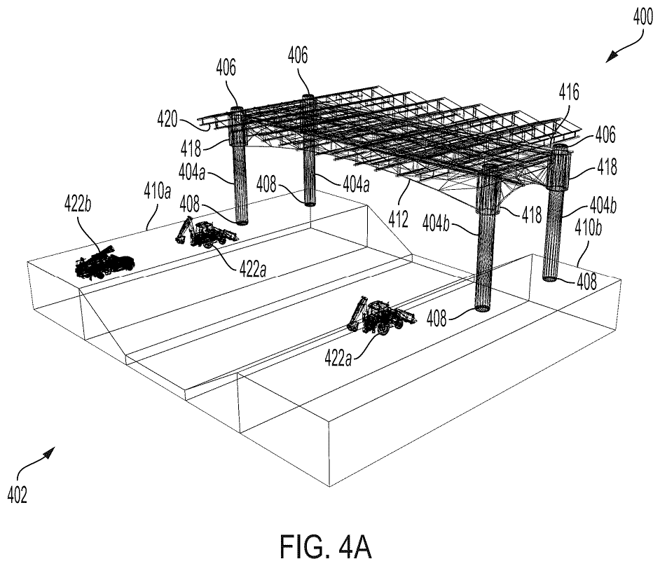

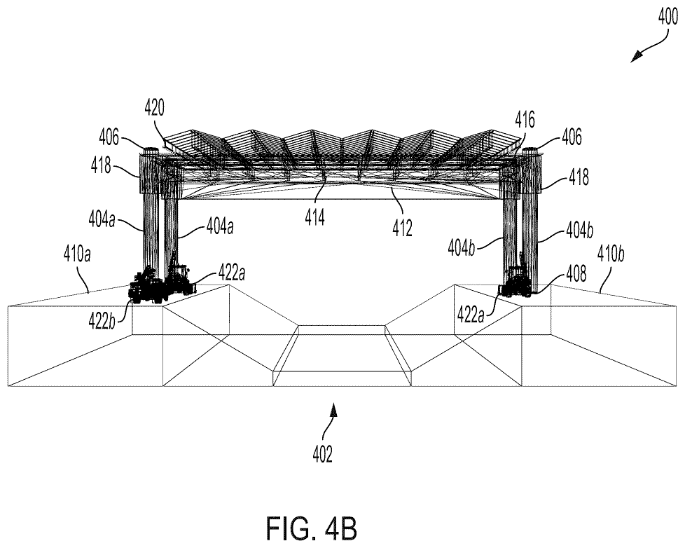

Now referring to FIG. 4A, a schematic diagram is presented, in perspective view of an example support structure 400 for supporting solar panels over a canal 402. FIG. 4B presents a schematic diagram, in elevation view, of the example support structure 400 of FIG. 4A. The example support structure 400 includes legs 404 formed of cementitious material. In some implementations, the legs 404 include layers of cementitious material that are successively deposited over one another by an additive manufacturing process (e.g., by 3D printing, by spray, etc.).

Each leg 404 has a length that positions an upper end 406 of the leg 404 above the canal 402 when a lower end 408 of the leg 404 contacts a bank 410 of the canal 402. The legs 404 may be aligned parallel to each other, and in certain cases, have the same length. In many implementations, the legs 404 include first legs 404a that are configured to be disposed on a first bank 410a of the canal 402. The legs also include second legs 404b that are configured to be disposed on a second bank 410b of the canal 402. The first and second banks 410a, 410b may be on opposite sides of the canal 402. In some instances, the legs 404 may include a hollow leg having an internal cavity that extends along at least a portion of the length of the hollow leg. The internal cavity may, for example, help reduce the weight of the example support structure 400 or define a conduit for electrical cables. Other functions are possible.

The example support structure 400 also includes a platform 412 that is formed of cementitious material and configured to span the canal 402. The platform 412 includes beams 414 that define an upper surface 416 of the platform 412 as well as leg interfaces 418 that are each configured to couple to one of the legs 404. During manufacture, grout or mortar may be added to the leg interfaces 418 to permanently secure the platform 412 to the legs 404 at respective positions along the lengths of the legs 404. In some implementations, the leg interfaces 418 each comprise a sleeve structure that is configured to contain a portion of one of the legs 404 therein. In some implementations, the platform 412 includes layers of cementitious material that are successively deposited over one another by an additive manufacturing process (e.g., by 3D printing, by spray, etc.)

In some implementations, such as shown in FIGS. 4A and 4B, the beams 414 include bank beams that are each configured to either: [1] connect a pair of first legs 404a to each other when the pair of first legs 404a are disposed on the first bank 410a, or [2] connect a pair of second legs 404b to each other when the pair of second legs 404b are disposed on the second bank 410b. In these implementations, the beams 414 also include spanning beams that are each configured to connect one of the first legs 404a to one of the second legs 404b when disposed on, respectively, the first and second banks 410a, 410b. In some instances, the legs 404 may include a shared leg that is shared by one of the bank beams and one of the spanning beams. As such, the leg interfaces 418 may include a corner leg interface that is configured to couple to the shared leg.

The example support structure 400 additionally includes a deck 420 that is configured to couple to the upper surface 416 of the platform 412 and secure one or more solar panels to the example support structure 400. In some instances, such as shown in FIGS. 4A and 4B, the deck 420 includes a scaffolding that is configured to couple to the one or more solar panels. However, the deck 420 may include other components (e.g., beams, planks, etc.) in lieu of or in addition to the scaffolding. In some implementations, such as shown in FIGS. 4A and 4B, the platform 412 and the deck 420 are positioned at a height that allow vehicles 422 (e.g., a front and backhoe loader 422a, an aerial lift truck 422b, etc.) to pass underneath the platform 412 and deck 420 as well as provide space for access to the canal 402 (e.g., such as for maintenance of the canal 402).

Now referring to FIG. 5A, a schematic diagram is presented, in perspective view, of an example floating support structure 500 that is moored to a floor 502 of a body of water 504. FIG. 5B presents a schematic diagram, in elevation view, of the example floating support structure 500 of FIG. 5A. The example floating support structure 500 may include a base 506 from which legs 508 extend upward. The base 506 may include mounts 510 that are configured to couple to mooring lines 512. During operation, and as shown in FIGS. 5A and 5B, anchors 514 may be embedded in the floor 502 of the body of water 504, and the base 506 may be connected to the anchors 514 by respective mooring lines 512. The legs 508 may each include upper ends that are configured to couple to a deck 516. The deck 516 is configured secure one or more solar panels 518 to the example floating support structure 500. In some implementations, one or both of the legs 508 and the base 506 are formed of cementitious materials. For example, one or both of the legs 508 and the base 506 may include layers of cementitious material that are successively deposited over one another by an additive manufacturing process (e.g., by 3D printing, by spray, etc.). In some implementations, one or more of the legs 508 may include an internal cavity therein, such as to reduce the weight of the example floating support structure 500 and possible to improve its buoyancy.

In some aspects of what is described, a support structure may be described by the following examples. The support structure may be configured to support solar panels over a body of water, such as at an offshore location.

Example 1. A support structure for supporting solar panels over a body of water, the support structure comprising:
legs formed of cementitious material, each leg having a length that is configured to position an upper end of the leg above a surface of the body of water when a lower end of the leg contacts a floor of the body of water;
a platform formed of cementitious material and comprising:
   beams that define an upper surface of the platform and comprise one or more perimeter beams that define a perimeter of the platform, and
   leg interfaces that are each configured to couple to one of the legs;
locking mechanisms that are each configured to:
   selectively secure and unsecure one of the leg interfaces to one of the legs, and
   allow the one leg interface, when unsecured, to move along at least a portion of the length of the one leg; and
a deck configured to couple to the upper surface of the platform and secure one or more solar panels to the support structure.

Example 2. The support structure of example 1, wherein the leg interfaces comprise:
perimeter leg interfaces disposed on the perimeter of the platform; and
an interior leg interface disposed in an interior of the platform that is contained within the perimeter.

Example 3. The support structure of example 2,
wherein the perimeter of the platform comprises a corner of the platform; and
wherein the perimeter leg interfaces comprise a corner leg interface that is disposed at the corner of the platform.

Example 4. The support structure of example 1 or any one of examples 2-3, wherein the deck comprises a scaffolding that is configured to couple to the one or more solar panels.

Example 5. The support structure of example 1 or any one of examples 2-4, wherein the leg interfaces each comprise a sleeve structure that is configured to contain a portion of one of the legs therein.

Example 6. The support structure of example 5,
wherein the legs each comprise a linear gear along at least a portion of the length of the leg
wherein the leg interfaces each comprise a circular gear configured to engage one of the linear gears of the legs; and
wherein the locking mechanisms each comprise a motor configured to couple to one of the circular gears of the leg interfaces.

Example 7. The support structure of example 1 or any one of examples 2-6, wherein the legs each have an outer diameter that increases in size proximate the lower end of the leg.

Example 8. The support structure of example 1 or any one of examples 2-7, wherein the lower end of at least one of the legs comprises a suction chamber that is configured to embed the lower end of the at least one leg into the floor of the body of water.

Example 9. The support structure of example 1 or any one of examples 2-8, wherein the legs comprise a hollow leg having an internal cavity that extends along at least a portion of the length of the hollow leg.

Example 10. The support structure of example 1 or any one of examples 2-9, wherein the legs or the platform comprise layers of cementitious material that are successively deposited over one another by an additive manufacturing process.

Example 11. The support structure of example 1 or any one of examples 2-10, comprising:
the one or more solar panels, coupled to the deck;
wherein the leg interfaces are each secured to one of the legs by one of the locking mechanisms; and
wherein the deck is coupled to the upper surface of the platform.

Example 12. The support structure of example 11,
wherein the beams define a lower surface of the platform; and
wherein the support structure comprises a buoyant body that is coupled to the lower surface of the platform.

Example 13. The support structure of example 11, wherein the lower ends of the legs are in contact with the floor of the body of water.

In some aspects of what is described, a support structure may be described by the following examples. The support structure may be configured to support solar panels over a body of water, such as at an offshore location. The support structure may include a base (e.g., a fixed-bottom base) that is configured to contact a floor of the body of water.

Example 14. A support structure for supporting solar panels over a body of water, the support structure comprising:
legs formed of cementitious material and aligned parallel to each other, each leg having a length that extends between upper and lower ends of the leg, the length configured to position the upper end of the leg above a surface of the body of water when a base of the support structure contacts a floor of the body of water;
the base, formed of cementitious material and configured to contact the floor of the body of water, the base comprising:
   a portion of each leg proximate its lower end,
   connecting members that connect respective pairs of the legs to each other proximate their lower ends, and
   compartments whose perimeters are defined by three or more of the connecting members; and
a deck configured to couple to the upper ends of the legs and secure one or more solar panels to the support structure.

Example 15. The support structure of example 14, wherein the deck comprises a scaffolding that is configured to couple to the one or more solar panels.

Example 16. The support structure of example 14 or example 15, wherein the connecting members comprise intersecting connecting members that intersect with at least one other intersecting connecting member.

Example 17. The support structure of example 14 or any one of examples 15-16,
wherein the base comprises a base surface that is configured to contact the floor of the body of water; and
wherein at least one of the connecting members comprises a penetrating surface that is part of the base surface and configured to penetrate the floor of the body of water.

Example 18. The support structure of example 14 or any one of examples 15-17, wherein the legs comprise a hollow leg having an internal cavity that extends along at least a portion of the length of the hollow leg.

Example 19. The support structure of example 14 or any one of examples 15-18, wherein the legs or the base comprise layers of cementitious material that are successively deposited over one another by an additive manufacturing process.

Example 20. The support structure of example 14 or any one of examples 15-19,
wherein the deck is coupled to the upper ends of the legs; and
wherein the support structure comprises the one or more solar panels, coupled to the deck.

### Example 21. the Support Structure of Example 20,

wherein the connecting members comprise perimeter connecting members that define, at least in part, a perimeter of the base;
wherein the legs comprise perimeter legs disposed on the perimeter of the base; and
wherein the support structure comprises an exterior buoyant body that is coupled to at least one of the perimeter legs and resides exterior to the base.

Example 22. The support structure of example 20 or example 21, comprising an interior buoyant body that is coupled to at least one of the connecting members and resides interior to one of the compartments of the base.

Example 23. The support structure of example 20, wherein the base is in contact with the floor of the body of water.

Example 24. The support structure of example 23, wherein the support structure is coupled to an anchor that is embedded in the floor of the body of water.

In some aspects of what is described, a method may be described by the following examples. The method may be used to deploy a support structure to a target location on a body of water. The support structure may include one or more solar panels coupled thereto. In some instances, the target location may be positioned over a second target location on a floor of the body of water. In these instances, the method may be used to deploy the support structure on to the second target location.

Example 25. A method of deploying a support structure, the method comprising:
floating, by operation of one or more buoyant bodies, the support structure from a first location on the body of water to a second location on the body of water, the one or more buoyant bodies coupled to a base of the support structure, the support structure comprising:
   legs formed of cementitious material and aligned parallel to each other, each leg having a length that extends between upper and lower ends of the leg, the length configured to position the upper end of the leg above a surface of the body of water when the base of the support structure contacts a floor of the body of water,
   the base, formed of cementitious material and configured to contact the floor of the body of water, the base comprising:
      a portion of each leg proximate its lower end,
      connecting members that connect respective pairs of the legs to each other proximate their lower ends, and
      compartments whose perimeters are defined by three or more of the connecting members, and
   a deck coupled to the upper ends of the legs, and
   one or more solar panels coupled to the deck; and
after reaching the second location, lowering the support structure onto the floor of the body of water.

Example 26. The method of example 25, wherein lowering the support structure comprises decoupling the one or more buoyant bodies from the base of the support structure.

Example 27. The method of example 25 or example 26,
wherein the one or more buoyant bodies comprise an inflatable buoyant body; and
wherein lowering the support structure comprises deflating, at least in part, the inflatable buoyant body.

Example 28. The method of example 25 or any one of examples 26-27, wherein lowering the support structure comprises contacting the base of the support structure with the floor of the body of water.

### Example 29. the Method of Example 28, Comprising:

disposing ballast into one or more of the compartments of the base after the base contacts the floor of the body of water.

Example 30. The method of example 28 or example 29, comprising:
embedding an anchor in the floor of the body of water; and
mooring the support structure to the anchor after the base contacts the floor of the body of water.

Example 31. The method of example 28 or any one of examples 29-30,
wherein the base comprises a base surface that contacts the floor of the body of water;
wherein at least one of the connecting members comprises a penetrating surface that is part of the base surface and configured to penetrate the floor of the body of water; and
wherein contacting the base of the support structure comprises penetrating the floor of the body of water with the penetrating surface of the at least one connecting member.

Example 32. The method of example 25 or any one of examples 26-31,
wherein the connecting members comprise perimeter connecting members that define, at least in part, a perimeter of the base;
wherein the legs comprise perimeter legs disposed on the perimeter of the base; and wherein the one or more buoyant bodies comprise an exterior buoyant body that is coupled to at least one of the perimeter legs and resides exterior to the base.

Example 33. The method of example 25 or any one of examples 26-32, wherein the one or more buoyant bodies comprise an interior buoyant body that is coupled to at least one of the connecting members and resides interior to one of the compartments of the base.

Example 34. The method of example 25 or any one of examples 26-33, wherein the connecting members comprise intersecting connecting members that intersect with at least one other intersecting connecting member.

Example 35. The method of example 25 or any one of examples 26-34, wherein the legs comprise a hollow leg having an internal cavity that extends along at least a portion of the length of the hollow leg.

In some aspects of what is described, a support structure may be described by the following examples. The support structure may be configured to support solar panels over a body of water, such as over a canal.

Example 36. A support structure for supporting solar panels over a canal, the support structure comprising:
legs formed of cementitious material, each leg having a length that positions an upper end of the leg above the canal when a lower end of the leg contacts a bank of the canal, the legs comprising:
   first legs configured to be disposed on a first bank of the canal,
   second legs configured to be disposed a second bank of the canal, the first and second banks on opposite sides of the canal; and
a platform formed of cementitious material and configured to span the canal, the platform comprising:
   beams that define an upper surface of the platform, and
   leg interfaces that are each configured to couple to one of the legs; and
a deck configured to couple to the upper surface of the platform and secure one or more solar panels to the support structure.

Example 37. The support structure of example 36, wherein the beams comprise:
bank beams that are each configured to:
   connect a pair of first legs to each other when the pair of first legs are disposed on the first bank, or
   connect a pair of second legs to each other when the pair of second legs are disposed on the second bank; and
spanning beams that are each configured to connect one of the first legs to one of the second legs when disposed on, respectively, the first and second banks.

Example 38. The support structure of example 37,
wherein the legs comprise a shared leg that is shared by one of the bank beams and one of the spanning beams; and
wherein the leg interfaces comprise a corner leg interface that is configured to couple to the shared leg.

Example 39. The support structure of example 36 or any one of examples 37-38, wherein the deck comprises a scaffolding that is configured to couple to the one or more solar panels.

Example 40. The support structure of example 36 or any one of examples 37-39, wherein the leg interfaces each comprise a sleeve structure that is configured to contain a portion of one of the legs therein.

Example 41. The support structure of example 36 or any one of examples 37-40, wherein the legs comprise a hollow leg having an internal cavity that extends along at least a portion of the length of the hollow leg.

Example 42. The support structure of example 36 or any one of examples 37-41, wherein the legs or the platform comprise layers of cementitious material that are successively deposited over one another by an additive manufacturing process.

Example 43. The support structure of example 36 or any one of examples 37-42, comprising:
the one or more solar panels, coupled to the deck;
wherein the first and second legs are disposed on, respectively, the first and second banks of the canal;
wherein the leg interfaces are coupled to respective ones of the legs;
wherein the deck is coupled to the upper surface of the platform; and
wherein the leg interfaces comprise grout or mortar that permanently secures the platform to the legs at respective positions along the lengths of the legs.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1.-13. (canceled)

14. A support structure for supporting solar panels over a body of water, the support structure comprising:
legs formed of cementitious material and aligned parallel to each other, each leg having a length that extends between upper and lower ends of the leg, the length configured to position the upper end of the leg above a surface of the body of water when a base of the support structure contacts a floor of the body of water;
the base, formed of cementitious material and configured to contact the floor of the body of water, the base comprising:
a portion of each leg proximate its lower end,
connecting members that connect respective pairs of the legs to each other proximate their lower ends, and
compartments whose perimeters are defined by three or more of the connecting members; and
a deck configured to couple to the upper ends of the legs and secure one or more solar panels to the support structure.

15. The support structure of claim 14, wherein the deck comprises a scaffolding that is configured to couple to the one or more solar panels.

16. The support structure of claim 14, wherein the connecting members comprise intersecting connecting members that intersect with at least one other intersecting connecting member.

17. The support structure of claim 14,
wherein the base comprises a base surface that is configured to contact the floor of the body of water; and
wherein at least one of the connecting members comprises a penetrating surface that is part of the base surface and configured to penetrate the floor of the body of water.

18. The support structure of claim 14,
wherein the legs comprise a hollow leg having an internal cavity that extends along at least a portion of the length of the hollow leg.

19. The support structure of claim 14,
wherein the legs or the base comprise layers of cementitious material that are successively deposited over one another by an additive manufacturing process.

20. The support structure of claim 14,
wherein the deck is coupled to the upper ends of the legs; and
wherein the support structure comprises the one or more solar panels, coupled to the deck.

21. The support structure of claim 20,
wherein the connecting members comprise perimeter connecting members that define, at least in part, a perimeter of the base;
wherein the legs comprise perimeter legs disposed on the perimeter of the base; and
wherein the support structure comprises an exterior buoyant body that is coupled to at least one of the perimeter legs and resides exterior to the base.

22. The support structure of claim 20, comprising an interior buoyant body that is coupled to at least one of the connecting members and resides interior to one of the compartments of the base.

23. The support structure of claim 20, wherein the base is in contact with the floor of the body of water.

24. The support structure of claim 23, wherein the support structure is coupled to an anchor that is embedded in the floor of the body of water.

25. A method of deploying a support structure, the method comprising:
floating, by operation of one or more buoyant bodies, the support structure from a first location on the body of water to a second location on the body of water, the one or more buoyant bodies coupled to a base of the support structure, the support structure comprising:
legs formed of cementitious material and aligned parallel to each other, each leg having a length that extends between upper and lower ends of the leg, the length configured to position the upper end of the leg above a surface of the body of water when the base of the support structure contacts a floor of the body of water,
the base, formed of cementitious material and configured to contact the floor of the body of water, the base comprising:
a portion of each leg proximate its lower end,
connecting members that connect respective pairs of the legs to each other proximate their lower ends, and
compartments whose perimeters are defined by three or more of the connecting members, and
a deck coupled to the upper ends of the legs, and
one or more solar panels coupled to the deck; and
after reaching the second location, lowering the support structure onto the floor of the body of water.

26. The method of claim 25, wherein lowering the support structure comprises decoupling the one or more buoyant bodies from the base of the support structure.

27. The method of claim 25,
wherein the one or more buoyant bodies comprise an inflatable buoyant body; and
wherein lowering the support structure comprises deflating, at least in part, the inflatable buoyant body.

28. The method of claim 25, wherein lowering the support structure comprises contacting the base of the support structure with the floor of the body of water.

29. The method of claim 28, comprising:
disposing ballast into one or more of the compartments of the base after the base contacts the floor of the body of water.

30. The method of claim 28 comprising:
embedding an anchor in the floor of the body of water; and
mooring the support structure to the anchor after the base contacts the floor of the body of water.

31. The method of claim 28,
wherein the base comprises a base surface that contacts the floor of the body of water;
wherein at least one of the connecting members comprises a penetrating surface that is part of the base surface and configured to penetrate the floor of the body of water; and
wherein contacting the base of the support structure comprises penetrating the floor of the body of water with the penetrating surface of the at least one connecting member.

32. The method of claim 25,
wherein the connecting members comprise perimeter connecting members that define, at least in part, a perimeter of the base;
wherein the legs comprise perimeter legs disposed on the perimeter of the base; and
wherein the one or more buoyant bodies comprise an exterior buoyant body that is coupled to at least one of the perimeter legs and resides exterior to the base.

33. The method of claim 25, wherein the one or more buoyant bodies comprise an interior buoyant body that is coupled to at least one of the connecting members and resides interior to one of the compartments of the base.

34. The method of claim 25, wherein the connecting members comprise intersecting connecting members that intersect with at least one other intersecting connecting member.

35.-43. (canceled)
